(19) United States
(12) Patent Application Publication
(10) Pub. No.: US 2018/0155574 A1
(43) Pub. Date: Jun. 7, 2018

(54) HYDROPHILIC POLYISOCYANATES BASED ON 1,5-DIISOCYANATOPENTANE

(71) Applicant: Covestro Deutschland AG, Leverkusen (DE)

(72) Inventors: Hans-Josef Laas, Odenthal (DE); Christoph Eggert, Köln (DE); Nusret Yuva, Burscheid (DE); Achim Meyer, Leverkusen (DE); Gesa Behnken, Köln (DE); Andreas Hecking, Langenfeld (DE)

(21) Appl. No.: 15/557,990

(22) PCT Filed: Mar. 14, 2016
(86) PCT No.: PCT/EP2016/055446

§ 371 Date: Sep. 13, 2017

(30) Foreign Application Priority Data
Mar. 16, 2015 (EP) 15159292.0

(51) Int. Cl. C09D 175/08; C09D 175/04; C08G 18/48; C08G 18/38; C08G 18/79

(52) U.S. Cl. CPC C09D 175/08; C09D 175/04; C08G 18/792; C08G 18/3857; C08G 18/4833

(57) ABSTRACT

The invention relates to a polyisocyanate composition based on 1,5-diisocyanatopentane, to a method for the production thereof and to the use thereof for producing polyurethane plastics. The invention also relates to a coating agent containing the polyisocyanate composition and to the coating obtained from the coating agent.

### CROSS-REFERENCE TO RELATED APPLICATIONS

This application is a national stage application (under 35 U.S.C. § 371) of PCT/EP2016/055446, filed Mar. 14, 2016, which claims benefit of European Application No. 15159292.0, filed Mar. 16, 2015 both of which are incorporated herein by reference in their entirety.

### FIELD OF THE INVENTION

The invention relates to a polyisocyanate composition based on 1,5-diisocyanatopentane (PDI), to a method for producing it, and to the use thereof for producing polyurethane plastics. Further subjects are a coating composition comprising the polyisocyanate composition, and the coating obtainable from the coating composition.

### BACKGROUND OF THE INVENTION

Aqueous paint systems have nowadays established themselves firmly for various areas of application, as an eco-friendly alternative to solvent-containing coating compositions. A particular role as a raw material for high-quality aqueous paints is played in this context by hydrophilically modified polyisocyanates, since as water-dispersible crosslinker components they allow the formulation of aqueous two-component polyurethane (2K PU) paints.

By far the greatest part of the hydrophilically modified polyisocyanates that are presently available commercially on the market are derived from polyisocyanates, more particularly polyisocyanurate-polyisocyanates, of 1,6-diisocyanatohexane (hexamethylene diisocyanate, HDI).

Hydrophilic HDI polyisocyanates can be incorporated finely and homogeneously into aqueous paint binder dispersions, even without use of high shearing forces, and this is beneficial to the application reliability and to the optical properties, particularly gloss and transparency, of the coatings obtained. At the same time, however, the hydrophilicity of the crosslinker component also significantly retards paint drying, since the water solvent is held for longer within the film. For a series of applications, such as for wood/furniture varnishing or for automotive refinishing and large-vehicle painting, however, rapid drying is a specific requirement.

Water-emulsifiable 1,5-diisocyanatopentane (PDI) derivatives that might serve as crosslinking agents for aqueous polymer dispersions were hitherto unknown.

Although PDI also gets a general mention in a series of publications relating to the hydrophilization of polyisocyanates, such as in WO 2014/048634, EP-A 0 953 585, JP 11100426, JP 2000178335, JP 2004010777 or JP 2007332193, within long lists, as starting diisocyanates suitable for the preparation of polyisocyanates, there have to date been no specific descriptions at all of hydrophilically modified, water-dispersible polyisocyanate mixtures based on PDI.

### SUMMARY OF THE INVENTION

The present invention provides new hydrophilically modified polyisocyanates which are suitable for all fields of application of water-dispersible polyisocyanates and which, especially in combination with customary aqueous paint binders, produce coatings which dry significantly more rapidly than those produced using the known hydrophilic HDI polyisocyanates of the prior art, while being by no means inferior to these prior-art coatings in terms of other paint properties, at the same time.

This has been achieved in accordance with the invention by means of a polyisocyanate composition comprising a polyisocyanate component A) and an emulsifier component B), wherein the polyisocyanate component A) consists of at least one polyisocyanate based on 1,5-diisocyanatopentane and the emulsifier component B) comprises at least one ionic and/or nonionic emulsifier.

The present invention also provides a method for producing these hydrophilically modified polyisocyanate compositions, and also the use thereof as starting components in the production of polyurethane plastics, especially as crosslinkers for water-soluble or -dispersible paint binders or paint-binder components having groups that are reactive toward isocyanate groups.

In one preferred embodiment, the hydrophilically modified polyisocyanate compositions of the invention, based on 1,5-diisocyanatopentane, consist of the polyisocyanate component A) and also of at least one ionic and/or nonionic emulsifier B).

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Polyisocyanate component A), also called starting polyisocyanates A) below, for producing the hydrophilic polyisocyanate composition of the invention are any desired oligomeric polyisocyanates which are obtainable by modification of 1,5-diisocyanatopentane and which have uretdione, isocyanurate, allophanate, biuret, iminooxadiazinedione and/or oxadiazinetrione structure, or any desired mixtures of such PDI polyisocyanates. These polyisocyanates are prepared by isocyanate oligomerization methods that are known per se, of the kind described for example in J. Prakt. Chem. 336 (1994) 185-200 and EP-A 0 798 299, by reaction of some of the isocyanate groups of the PDI, to form polyisocyanate molecules consisting of at least two diisocyanate molecules, and by generally subsequent distillative or extractive removal of the unreacted monomeric PDI. In one embodiment of the invention, therefore, they consist of the starting components, the reaction products, and possibly small amounts of residual monomer as well. Specific examples of such oligomeric PDI polyisocyanates are found for example in EP-A 2 418 198, EP-A 2 684 867, JP 2010-121011, JP 2010-254764, JP 2010-265364, JP 2011-201863, JP 2012-152202, JP 2013-060542. Preferred polyisocyanates are those having isocyanurate and/or allophanate structure, more preferably having isocyanurate structure.

The 1,5-diisocyanatopentane used for preparing the polyisocyanate component A) is obtainable in a variety of ways, as for example by phosgenation in the liquid phase or gas phase, or by a phosgene-free route, such as, for example, by thermal cleavage of urethane, starting from 1,5-diaminopentane obtained preferably by a biotechnological route of decarboxylation of the naturally occurring amino acid lysine.

Optionally, in the preparation of the polyisocyanate component A), diisocyanates other than 1,5-diisocyanatopentane may also be used, these diisocyanates having aliphatically, cycloaliphatically, araliphatically and/or aromatically bonded isocyanate groups. Such diisocyanates are, in particular, those of the molecular weight range 140 to 400, such as, for example, 1,4-diisocyanatobutane, 1,6-diisocyanatohexane (HDI), 2-methyl-1,5-diisocyanatopentane, 1,5-diisocyanato-2,2-dimethylpentane, 2,2,4- and/or 2,4,4-trimethyl-1,6-diisocyanatohexane, 1,10-diisocyanatodecane, 1,3- and 1,4-diisocyanatocyclohexane, 2,4- and 2,6-diisocyanato-1-methylcyclohexane, 1,3- and 1,4-bis(isocyanato-methyl)cyclohexane, 1-isocyanato-3,3,5-trimethyl-5-isocyanatomethylcyclohexane (isophorone diisocyanate, IPDI), 4,4′-diisocyanatodicyclohexylmethane, 2,4′-diisocyanatodicyclohexylmethane, 1-isocyanato-1-methyl-4(3)-isocyanatomethylcyclohexane, bis(isocyanatomethyl)norbornane, 1,3- and 1,4-bis(isocyanatomethyl)benzene (XDI), 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylmethane (MDI), 1,5-diisocyanatonaphthalene, or any desired mixtures of such diisocyanates.

These diisocyanates for optional additional use in the preparation of the polyisocyanate components A) are employed, if at all, in amounts of up to 80 wt %, preferably up to 50 wt %, more preferably up to 20 wt %, based on the total amount of diisocyanates employed.

A subject of the invention, accordingly, is a polyisocyanate composition wherein the composition has an average isocyanate functionality of 1.8 to 8.0, preferably of 2.0 to 7.0, and more preferably of 2.3 to 6.0, and/or has an isocyanate group content of 5.0 to 26.0 wt %, preferably 6.0 to 24.0 wt %, and more preferably of 10.0 to 23.0 wt %.

A preferred polyisocyanate composition comprises a polyisocyanate component A) of at least one polyisocyanurate having an average NCO functionality of 2.3 to 5.0 and/or an isocyanate group content of 11.0 to 26.0 wt %.

Particularly preferred is a polyisocyanate composition comprising a polyisocyanate component A) and an emulsifier component B) wherein the polyisocyanate component A) consists of at least one polyisocyanurate which is based on 1,5-diisocyanatopentane and which has an average NCO functionality of 2.3 to 5.0 and/or an isocyanate group content of 11.0 to 26.0 wt %, and the emulsifier component B) comprises at least one ionic and/or nonionic emulsifier.

Especially preferred polyisocyanate components A) are polyisocyanates which contain isocyanurate structures, have been prepared using PDI as sole diisocyanate, and have an average NCO functionality of 2.3 to 5.0, preferably of 2.5 to 4.5, an isocyanate group content of 11.0 to 26.0 wt %, preferably of 13.0 to 25.0 wt %, and a monomeric PDI content of less than 1.0 wt %, preferably less than 0.5 wt %.

The hydrophilically modified polyisocyanate composition of the invention based on 1,5-diisocyanatopentane comprise not only the polyisocyanate components A) but also at least one ionic and/or nonionic emulsifier B).

These are any desired surface-active substances which on account of their molecular structure are capable of stabilizing polyisocyanates or polyisocyanate composition in aqueous emulsions over a prolonged period, preferably up to 8 hours.

Likewise a subject of the invention is a method for producing the polyisocyanate composition wherein the polyisocyanate component A) is mixed with the emulsifier component B), or the emulsifier component B) is formed in the polyisocyanate component A) by proportional reaction of polyisocyanates of the polyisocyanate component A) with ionic and/or nonionic compounds which carry groups that are reactive toward isocyanate groups.

A preferred kind of nonionic emulsifiers B) is represented, for example, by reaction products B1) of the polyisocyanate components A) with hydrophilic polyether alcohols.

Suitable hydrophilic polyether alcohols are monohydric or polyhydric polyalkylene oxide polyether alcohols which have on average 5 to 50 ethylene oxide units per molecule and are of the kind obtainable conventionally by alkoxylation of suitable starter molecules (see, for example, Ullmann's Encyclopädie der technischen Chemie, 4^{th} edition, volume 19, Verlag Chemie, Weinheim pp. 31-38). Starter molecules of this kind may be, for example, any desired monohydric or polyhydric alcohols of the molecular weight range 32 to 300, such as, for example, methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, the isomeric methyl-cyclohexanols, hydroxymethylcyclohexane, 3-methyl-3-hydroxymethyloxetane, benzyl alcohol, phenol, the isomeric cresols, octylphenols, nonylphenols, and naphthols, furfuryl alcohol, tetrahydrofurfuryl alcohol, 1,2-ethanediol, 1,2- and 1,3-propanediol, the isomeric butanediols, pentanediols, hexanediols, heptanediols, and octanediols, 1,2- and 1,4-cyclohexanediol, 1,4-cyclohexanedimethanol, 4,4′-(1-methylethylidene) biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol or 1,3,5-tris(2-hydroxyethyl) isocyanurate.

Alkylene oxides suitable for the alkoxylation reaction are, in particular, ethylene oxide and propylene oxide, which can be used in any order or else in a mixture in the alkoxylation reaction. Suitable polyether alcohols are either pure polyethylene oxide polyether alcohols or mixed polyalkylene oxide polyethers whose alkylene oxide units consist to an extent of at least 70 mol %, preferably at least 80 mol %, of ethylene oxide units.

Preferred polyalkylene oxide polyether alcohols are those prepared using the aforementioned monoalcohols of the molecular weight range 32 to 150 as starter molecules. Particularly preferred polyether alcohols are pure polyether glycol monomethyl ether alcohols having on average 5 to 50, very preferably 5 to 25, ethylene oxide units.

The preparation of such preferred nonionic emulsifiers B1) is known in principle and described for example in EP-B 0 206 059 and EP-B 0 540 985.

The preparation may take place by reaction of the polyisocyanate components A) with the stated polyether alcohols, either in a separate reaction step with subsequent mixing of the resulting emulsifier B1) with the polyisocyanate components A) to be converted into a hydrophilic form, or else by blending the polyisocyanate components A) with a corresponding amount of the polyether alcohols, with spontaneous formation of a hydrophilic polyisocyanate mixture of the invention which as well as unreacted polyisocyanate A) contains the emulsifier B) which forms in situ from the polyether alcohol and a part of the component A).

This kind of nonionic emulsifiers B1) is generally prepared at temperatures of 40 to 180° C., preferably 50 to 150° C., with observance of an NCO/OH equivalent ratio of 2:1 to 400:1, preferably of 4:1 to 140:1.

In the first-mentioned variant of the separate preparation of the nonionic emulsifiers B1), they are prepared preferably with observance of an NCO/OH equivalent ratio of 2:1 to 6:1. In the case of the preparation of the emulsifiers B1) in situ, it is of course possible to employ a large excess of isocyanate groups within the broad range specified above.

The reaction of the polyisocyanate component A) with the stated hydrophilic polyether alcohols to form nonionic emulsifiers B1) may also be performed, in accordance with the process described in EP-B 0 959 087, in such a way that the urethane groups formed primarily, by NCO/OH reaction, are further reacted at least proportionally, preferably to an extent of at least 60 mol %, to form allophanate groups, based on the sum of urethane groups and allophanate groups. In this case, reactants are reacted in the above-stated NCO/OH equivalent ratio at temperatures of 40 to 180° C., preferably 50 to 150° C., generally in the presence of the catalysts that are set out in the cited patents and are suitable for accelerating the allophanatization reaction, more particularly zinc compounds, such as zinc(II) n-octanoate, zinc(II) 2-ethyl-1-hexanoate or zinc(II) stearate, for example.

A further preferred type of suitable nonionic emulsifiers B) is represented, for example, by reaction products of monomeric diisocyanates or of diisocyanate mixtures with the above-stated, monohydric or polyhydric, hydrophilic polyether alcohols, in an OH/NCO equivalent ratio of 0.6:1 to 1.2:1. Especially preferred is the reaction of monomeric diisocyanates or diisocyanate mixtures with pure polyethylene glycol monomethyl ether alcohols having on average 5 to 50, preferably 5 to 25, ethylene oxide units. The preparation of such emulsifiers B2) is likewise known and described for example in EP-B 0 486 881.

Optionally, however, the emulsifiers B2), following the blending of the components in the proportions described above, may also be reacted in the presence of suitable catalysts with the polyisocyanates A) in an allophanatization process. In this case, again, hydrophilic polyisocyanate composition of the invention are formed which as well as unreacted polyisocyanate A) include a further nonionic emulsifier type B3) with allophanate structure that is formed in situ from the emulsifier B2) and a part of the component A). The preparation of such emulsifiers B3) in situ is also already known and described for example in WO 2005/047357.

The hydrophilically modified polyisocyanate compositions of the invention, based on 1,5-diisocyanatopentane, may comprise, instead of the nonionic emulsifiers described by way of example, emulsifiers having ionic, more particularly anionic, groups.

A further subject of the invention are polyisocyanate compositions wherein the emulsifier component B) comprises at least one reaction product of at least one polyisocyanate of the polyisocyanate component A) with an aminosulfonic acid.

Such ionic emulsifiers B) preferably constitute sulfonate-group-containing emulsifiers B4), of the kind obtainable, for example, by the method of WO 01/88006 by reaction of the polyisocyanate components A) with 2-(cyclohexylamino)ethanesulfonic acid and/or 3-(cyclohexylamino)-propanesulfonic acid or else with 4-(cyclohexylamino)butanesulfonic acid. This reaction takes place in general at temperatures of 40 to 150° C., preferably 50 to 130° C., with observance of an equivalent ratio of NCO groups to amino groups of 2:1 to 400:1, preferably of 4:1 to 250:1; to neutralize the sulfonic acid groups, tertiary amines are used additionally, preferably in an equimolar amount relative to the amount of aminosulfonic acid. Suitable neutralizing amines are, for example, tertiary monoamines, such as, for example, trimethylamine, triethylamine, tripropylamine, tributylamine, dimethylcyclohexylamine, diisopropylethylamine, N-methylmorpholine, N-ethylmorpholine, N-methyl-piperidine, or N-ethylpiperidine, tertiary diamines, such as, for example, 1,3-bis(dimethylamino)propane, 1,4-bis(dimethylamino)butane or N,N′-dimethylpiperazine, or, less preferably, alkanolamines, such as, for example, dimethylethanolamine, methyldiethanolamine or triethanolamine.

The already described for the nonionic emulsifiers B1), the reaction of the polyisocyanate components A) with the stated aminosulfonic acids may also take place either in a separate reaction step with subsequent mixing of the resultant ionic emulsifiers B4) with the polyisocyanate components A) to be converted into a hydrophilic form, or else in situ in these polyisocyanate components, in which case a hydrophilic polyisocyanate mixture of the invention is formed directly, this mixture comprising not only unreacted polyisocyanate A) but also the emulsifier B4) which forms in situ from the aminosulfonic acids, the neutralizing amine, and a part of the components A).

Another preferred type of suitable emulsifiers B) are those which at the same time contain ionic and nonionic structures in one molecule. These emulsifiers B5) are, for example, alkylphenol polyglycol ether phosphates and phosphonates, or fatty alcohol polyglycol ether phosphates and phosphonates, neutralized with tertiary amines, such as, for example, the abovementioned neutralizing amines, these phosphates and phosphonates being as described, for example, in WO 97/31960 for the hydrophilization of polyisocyanates, or else are alkylphenol polyglycol ether sulfates or fatty alcohol polyglycol ether sulfates neutralized with tertiary amines of this kind.

In this case, the emulsifier component preferably comprises at least one alkali metal salt or ammonium salt of an alkylphenol polyglycol ether phosphate, alkylphenol polyglycol ether phosphonate, fatty alcohol polyglycol ether phosphate, fatty alcohol polyglycol ether phosphonate, alkylphenol polyglycol ether sulfate and/or fatty alcohol polyglycol ether sulfate.

Irrespective of the nature of the emulsifier B) and its preparation, the amount thereof and/or the amount of the ionic and/or nonionic components added to the polyisocyanates A) in the case of preparation of the emulsifier in situ are generally calculated such that the 1,5-diisocyanatopentane-based polyisocyanate composition ultimately obtained, hydrophilically modified in accordance with the invention, comprise an amount of emulsifier B) that ensures the dispersibility of the polyisocyanate mixture.

Otherwise, nature and proportions of the starting components are selected, within the bounds of the details given, in each case such that the resultant polyisocyanate composition meet the specifications a) and b) wherein a) the average NCO functionality is preferably 2.0 to 8.0, more preferably 2.3 to 6.0, and b) the NCO content is preferably 6.0 to 24.0 wt %, more preferably 10.0 to 23.0 wt %.

The 1,5-diisocyanatopentane-based, hydrophilically modified polyisocyanate composition of the invention, consisting of polyisocyanate component A) and also of at least one ionic and/or nonionic emulsifier B), may be prepared solventlessly or, optionally, in a suitable solvent that is inert toward isocyanate groups. Suitable solvents are, for example, the customary paint solvents that are known per se, such as, for example, ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, more highly substituted aromatics, of the kind available commercially for example under the names SOLVENTNAPHTHA, SOLVESSO, ISOPAR, NAPPAR (Deutsche EXXON CHEMICAL GmbH, Cologne, DE) and SHELLSOL (Deutsche Shell Chemie GmbH, Eschborn, DE), carbonic esters, such as dimethyl carbonate, diethyl carbonate, 1,2-ethylene carbonate and 1,2-propylene carbonate, lactones, such as β-propiolactone, γ-butyrolactone, ε-caprolactone and ε-methylcaprolactone, but also solvents such as propylene glycol diacetate, diethylene glycol dimethyl ether, dipropylene glycol dimethyl ether, diethylene glycol ethyl and butyl ether acetates, N-methylpyrrolidone and N-methylcaprolactam, or any desired mixtures of such solvents.

The hydrophilically modified polyisocyanate composition of the invention based on 1,5-diisocyanatopentane represent clear, pale-colored polyisocyanate mixtures which can be dispersed easily into water by mere stirred incorporation, without using high shearing forces. In comparison to the known hydrophilic polyisocyanates of the prior art that are based on 1,6-diisocyanatohexane, a much lower total emulsifier content is sufficient in itself to give sedimentation-stable aqueous dispersions on use of emulsifier types B) that are the same in each case, surprisingly.

This means that hydrophilically modified PDI polyisocyanate composition produced using in each case the same quantitative fractions of the same kind of emulsifier types B) result in more finely divided aqueous dispersions than do analogously constructed, water-dispersible HDI polyisocyanates of the prior art.

Furthermore, the paint films produced with the hydrophilic PDI polyisocyanate composition of the invention, for a given fraction of the same kind of emulsifier types B), also exhibit much more rapid drying than water-dispersible HDI polyisocyanates, and this constitutes a considerable advantage in a range of applications, as for example in wood/furniture varnishing or in automotive refinishing and large-vehicle painting.

The outstanding dispersibility even at low levels of emulsifier in compounds having high NCO contents and NCO functionalities represents an advantage especially for the use of the hydrophilically modified polyisocyanate composition of the invention in aqueous 2K PU paints, because in this way it is possible to obtain highly crosslinked coatings which have good solvent resistance and chemical resistance which also exhibit excellent water resistance, due to the low level of hydrophilic groups.

Optionally, prior to the emulsification, any desired further, nonhydrophilicized polyisocyanates, especially PDI polyisocyanates of the aforementioned kind, may be added to the hydrophilically modified polyisocyanate composition of the invention, based on 1,5-diisocyanatopentane; if this is the case, the proportions are preferably selected such that the resultant polyisocyanate mixtures meet the conditions stated above under a) to b), and therefore likewise constitute polyisocyanate composition of the invention, since these in general consist of mixtures of
(i) 1,5-diisocyanatopentane-based polyisocyanates modified hydrophilically in accordance with the invention, and
(ii) unmodified polyisocyanates of the type exemplified.

In such mixtures, the hydrophilically modified polyisocyanates of the invention take on the function of an emulsifier for the subsequently admixed fraction of nonhydrophilic polyisocyanates.

The polyisocyanate compositions of the invention represent valuable starting materials for the production of polyurethane plastics, especially by the isocyanate polyaddition process, and are used for that purpose.

Likewise a subject of the invention are coating compositions comprising at least one of the above-described polyisocyanate compositions and also at least one compound that is reactive toward isocyanate groups, and, optionally, further auxiliaries and adjuvants.

For this purpose, the polyisocyanate compositions are used preferably in the form of aqueous emulsions, which in combination with polyhydroxyl compounds in dispersion in water may be reacted to form aqueous two-component systems.

With particular preference, the polyisocyanate compositions of the invention are used as crosslinkers for aqueous solutions or dispersions of paint binders or paint-binder components having groups that are reactive toward isocyanate groups, more particularly having alcoholic hydroxyl groups, in the production of coatings using aqueous coating compositions based on such binders and/or binder components. Here, the crosslinker, optionally in emulsified form, may be combined with the binders or binder components by simple stirring together before the coating compositions are processed, by any desired methods, or else using two-component spray guns.

In this context, the following may be mentioned by way of example as paint binders or paint-binder components: aqueous solutions or dispersions of polyacrylates containing hydroxyl groups, more particularly polyacrylates of the molecular weight range 1000 to 10 000, which, with organic polyisocyanates as crosslinkers, represent valuable two-component binders, or aqueous dispersions of optionally urethane-modified, hydroxyl-containing polyester resins of the kind known from polyester and alkyd resin chemistry. Suitable in principle as reactants for the polyisocyanate compositions of the invention are all aqueous solutions or dispersions of binders which have groups reactive toward isocyanates. They also include, for example, aqueous dispersions of polyurethanes or polyureas which are crosslinkable with polyisocyanates on account of the active hydrogen atoms that are present in the urethane or urea groups, respectively.

In the context of the inventive use as a crosslinker component for aqueous paint binders, the polyisocyanate compositions of the invention are used generally in amounts corresponding to an equivalent ratio of NCO groups to groups reactive toward NCO groups, more particularly to alcoholic hydroxyl groups, of 0.5:1 to 2:1.

In minor amounts, the polyisocyanate compositions of the invention may also, optionally, be admixed to nonfunctional aqueous paint binders in order to obtain highly specific properties—for example, as an additive for improving adhesion.

Of course, the polyisocyanate compositions of the invention can also be used in a form blocked with blocking agents known per se from polyurethane chemistry, in combination with the aforementioned aqueous paint binders or paint binder components, as aqueous one-component PU baking systems. Examples of suitable blocking agents are diethyl malonate, ethyl acetoacetate, acetone oxime, butanone oxime, ε-caprolactam, 3,5-dimethylpyrazole, 1,2,4-triazole, dimethyl-1,2,4-triazole, imidazole, or any desired mixtures of these blocking agents.

Substrates contemplated for the aqueous coatings formulated by means of the polyisocyanate compositions of the invention include any desired substrates, such as metal, wood, glass, stone, ceramic materials, concrete, rigid and flexible plastics, textiles, leather, and paper, for example, which prior to coating may optionally also be provided with customary primers.

In general, the aqueous coating compositions formulated with the polyisocyanate compositions of the invention, and in which optionally the auxiliaries and additives customary in the paint sector—such as flow control assistants, color pigments, fillers, dulling agents or emulsifiers, for example—may be incorporated, have good technical paint properties even on room-temperature drying.

Of course, however, they may also be dried under forced conditions at elevated temperature and/or by baking at temperatures up to 260° C.

On account of their outstanding emulsifiability in water, allowing homogeneous, particularly fine distribution in aqueous paint binders, the use of the polyisocyanate compositions of the invention as a crosslinker component for aqueous polyurethane paints leads to coatings having outstanding optical properties, particularly high surface gloss, leveling, and high transparency.

Besides the preferred use as crosslinker components for aqueous 2K PU paints, the hydrophilically modified polyisocyanate compositions of the invention, based on PDI, are outstandingly suitable as crosslinkers for aqueous dispersion-based adhesives, leather coatings and textile coatings or textile printing pastes, as AOX-free paper auxiliaries, or else as additives for mineral construction materials, such as concrete or mortar compositions, for example.

Likewise a subject of the invention is a coating obtainable by using the coating compositions described above.

### EXAMPLES

The non-limiting and non-exhaustive examples that follow are intended to further describe various non-limiting and non-exhaustive embodiments without restricting the scope of the embodiments described in this specification. All percentages are given, unless the contrary is stated, by weight.

The NCO contents were determined by titrimetry in accordance with DIN EN ISO 11909.

The residual monomer contents were measured by gas chromatography with an internal standard in accordance with DIN EN ISO 10283.

All viscosity measurements were made with a PHYSICA MCR 51 Rheometer from Anton Paar Germany GmbH (DE) in accordance with DIN EN ISO 3219.

Average particle sizes for aqueous dispersions were determined using a ZETASIZER, model DTS 5100, from Malvern Instruments GmbH (DE).

The Hazen color number was measured spectrophotometrically in accordance with DIN EN 1557 with a LICO 400 spectrophotometer from Lange, DE.

### Polyisocyanate Component A

### Polyisocyanate Component A1

1000 g (6.49 mol) of pentamethylene 1,5-diisocyanate (PDI) were charged to a four-neck flask equipped with stirrer, reflux condenser, N₂ passage tube, and internal thermometer, degassed three times at room temperature by application of a reduced pressure of approximately 50 mbar, and blanketed with nitrogen. The batch was then heated to 60° C. and the catalyst solution (1.5% strength N,N,N-trimethyl-N-benzylammonium hydroxide solution in a 1:1 mixture of methanol and 2-ethyl-1-hexanol) was metered in at a rate such that the temperature of the reaction mixture warmed to not more than 80° C. in spite of the trimerization reaction with its exothermic onset. When an NCO content of 47.8 wt % was reached, the reaction was stopped with dibutyl phosphate (equimolar amount based on trimethylbenzylammonium hydroxide employed) and the unreacted monomeric PDI was separated off in a thin-film evaporator at a temperature of 140° C. and a pressure of 0.5 mbar. This gave a virtually colorless polyisocyanurate polyisocyanate having the following characteristic data:

NCO content: 24.2%
NCO functionality (calc.): 3.3
Viscosity (23° C.): 2200 mPas
monomeric PDI: 0.06%
Color number (APHA): 30 Hazen

### Polyisocyanate Component A2

By the method described for polyisocyanate component A1), and using the catalyst solution described there, 1000 g (6.49 mol) of PDI were reacted to an NCO content of 36.7%. Deactivation of the catalyst and subsequent distillative removal of the unreacted monomeric PDI by means of a thin-film evaporator at 140° C. and 0.5 mbar gave a virtually colorless polyisocyanurate polyisocyanate having the following characteristic data:

NCO content: 21.7%
NCO functionality (calc.): 3.5
Viscosity (23° C.): 9850 mPas
monomeric PDI: 0.05%
Color number (APHA): 34 Hazen

### Example 1

### (Inventive, Emulsifier Type B1)

870 g (4.50 eq) of the polyisocyanate component A2) were introduced at 100° C. under dry nitrogen and with stirring, admixed over the course of 30 minutes with 130 g (0.37 eq) of a methanol-started, monofunctional polyethylene oxide polyether with an average molecular weight of 350, and stirred further at this temperature until after about 2 hours the NCO content of the mixture had dropped to a figure of 17.3%. Cooling to room temperature gave a colorless, clear polyisocyanate mixture having the following characteristic data:

NCO content: 17.3%
NCO functionality: 3.2
Viscosity (23° C.): 9600 mPas
Color number (APHA): 28 Hazen

### Example 2

### (Comparative, Hydrophilic HDI Polyisocyanate as Per EP-B 0 540 985, Emulsifier Type B1)

870 g (4.50 eq) of a polyisocyanate containing isocyanurate groups and based on HDI, having an NCO content of 21.7%, an average NCO functionality of 3.5 (by GPC), a monomeric HDI content of 0.1%, and a viscosity of 3000 mPas (23° C.) were introduced at 100° C. under dry nitrogen and with stirring, admixed over the course of 30 minutes with 130 g (0.37 eq) of a methanol-started, monofunctional polyethylene oxide polyether with an average molecular weight of 350, and stirred further at this temperature until after about 2 hours the NCO content of the mixture had dropped to a figure of 17.4%. Cooling to room temperature gave a colorless, clear polyisocyanate mixture having the following characteristic data:

NCO content: 17.4%
NCO functionality: 3.2
Viscosity (23° C.): 2800 mPas
Color number: 40 APHA

### Example 3

### (Inventive, Emulsifier Type B1)

850 g (4.39 eq) of the polyisocyanate component A2) were introduced at 100° C. under dry nitrogen and with stirring, admixed over the course of 30 minutes with 150 g (0.30 eq) of a methanol-started, monofunctional polyethylene oxide polyether with an average molecular weight of 500, and then stirred further at this temperature until after about 2 hours the NCO content of the mixture had dropped to the figure of 17.2%, corresponding to complete urethanization. Subsequently 0.01 g of zinc(II) 2-ethyl-1-hexanoate was added as allophanatization catalyst. The temperature of the reaction mixture rose here, owing to the heat of reaction released, to 107° C. When the exothermic reaction had subsided, around 30 minutes after addition of catalyst, the reaction was discontinued by addition of 0.01 g of benzoyl chloride and the reaction mixture was cooled to room temperature. This gave an inventive, virtually colorless, clear polyisocyanate mixture having the following characteristic data:

Solids content: 100%
NCO content: 16.4%
NCO functionality: 4.0
Viscosity (23° C.): 16400 mPas
Color number: 50 APHA

### Example 4

### (Comparative, Hydrophilic HDI Polyisocyanate as Per EP-B 0 959 087, Emulsifier Type B1)

850 g (4.39 eq) of the HDI-based polyisocyanate containing isocyanurate groups and described in connection with the preparation of the comparative polyisocyanate A2) were introduced at 100° C. under dry nitrogen and with stirring, admixed over the course of 30 minutes with 150 g (0.30 eq) of a methanol-started, monofunctional polyethylene oxide polyether with an average molecular weight of 500, and then stirred further at this temperature until after about 2 hours the NCO content of the mixture had dropped to the figure of 17.2%, corresponding to complete urethanization. Subsequently 0.01 g of zinc(II) 2-ethyl-1-hexanoate was added as allophanatization catalyst. The temperature of the reaction mixture rose here, owing to the heat of reaction released, to 102° C. When the exothermic reaction had subsided, around 30 minutes after addition of catalyst, the reaction was discontinued by addition of 0.01 g of benzoyl chloride and the reaction mixture was cooled to room temperature. This gave an inventive, virtually colorless, clear polyisocyanate mixture having the following characteristic data:

NCO content: 16.4%
NCO functionality: 4.0
Viscosity (23° C.): 7100 mPas
Color number: 38 APHA

### Example 5

### (Inventive, Emulsifier Type B4)

A mixture of 980 g (5.65 eq) of the polyisocyanate component A1) were stirred together with 20 g (0.09 eq) of 3-(cyclohexylamino)propanesulfonic acid (CAPS) and 11 g (0.09 mol) of dimethylcyclohexylamine under dry nitrogen at 80° C. for 3 hours. Cooling to room temperature gave an inventive, virtually colorless, clear polyisocyanate mixture having the following characteristic data:

NCO content: 23.1%
NCO functionality: 3.2
Viscosity (23° C.): 2800 mPas
Color number: 45 APHA

### Example 6

(Comparative, Hydrophilic HDI Polyisocyanate as Per WO 01/88006, Emulsifier type B4)

980 g (5.37 eq) of an HDI-based polyisocyanate containing isocyanurate groups and having an NCO content of 23.0%, an average NCO functionality of 3.3 (by GPC), a monomeric HDI content of 0.1%, and a viscosity of 1200 mPas (23° C.) were stirred together with 20 g (0.09 eq) of 3-(cyclohexylamino)propanesulfonic acid (CAPS) and 11 g (0.09 mol) of dimethylcyclohexylamine under dry nitrogen at 80° C. for 3 hours. Cooling to room temperature gave an inventive, virtually colorless, clear polyisocyanate mixture having the following characteristic data:

NCO content: 21.9%
NCO functionality: 3.2
Viscosity (23° C.): 1700 mPas
Color number: 41 APHA

### Example 7

### (Inventive, Emulsifier Type B5)

890 g (4.60 eq) of the polyisocyanate component A2) were stirred for 12 hours at 80° C. with 110 g of an emulsifier mixture consisting of 97 g of an ethoxylated tridecyl alcohol phosphate (RHODAFAC RS-710, Rhodia) and 13 g of dimethylcyclohexylamine as neutralizing amine. After cooling to room temperature, the resulting colorless, clear polyisocyanate mixture has the following characteristic data:

NCO content: 19.3%
NCO functionality: 3.5
Viscosity (23° C.): 9200 mPas
Color number: 33 APHA

### Example 8

### (Comparative, Hydrophilic HDI Polyisocyanate as Per WO 97/31960, Emulsifier Type B4)

890 g (4.60 eq) of the HDI-based polyisocyanate containing isocyanurate groups and described in connection with the preparation of the polyisocyanate component A1) are stirred for 12 hours at 80° C. with 110 g of an emulsifier mixture consisting of 97 g of an ethoxylated tridecyl alcohol phosphate (RHODAFAC RS-710, Rhodia) and 13 g of dimethylcyclohexylamine as neutralizing amine After cooling to room temperature, the resulting colorless, clear polyisocyanate mixture has the following characteristic data:

NCO content: 19.3%
NCO functionality: 3.5
Viscosity (23° C.): 2900 mPas
Color number: 26 APHA

### Example 9

### (Preparation of Emulsions)

28 g of each of the inventive polyisocyanate compositions (polyisocyanate mixtures) from Examples 1, 3, 5 and 7 and also of the comparative polyisocyanates from Examples 2, 4, 6 and 8 were diluted both in cosolvent-free form and with 12 g each of 1-methoxyprop-2-yl acetate (MPA), admixed with 100 g of deionized water in an Erlenmeyer flask, and then stirred each for 1 minute at 900 rpm with a magnetic stirrer. The average particle size of the resulting emulsions, as a measure of the dispersibility of the different polyisocyanate mixtures, was determined by means of a “ZETASIZER” instrument from Malvern Instruments. The table below shows the values found.

| | | Average |
|---|---|---|
| Polyisocyanate | Average particle size [nm] | particle size [nm] |
| mixture from | cosolvent-free | 70% strength in MPA |
| Ex. 1 | 121 | 344 |
| Ex. 2 (comparative) | 138 | 594 |
| Ex. 3 | 96 | 75 |
| Ex. 4 (comparative) | 118 | 85 |
| Ex. 5 | 228 | 211 |
| Ex. 6 (comparative) | 329 | 256 |
| Ex. 7 | 223 | 274 |
| Ex. 8 (comparative) | 240 | 290 |

The comparison shows that the inventive, hydrophilically modified polyisocyanate mixtures based on PDI from Examples 1, 3, 5 and 7 have much better dispersibility than the water-dispersible HDI polyisocyanates from Examples 2, 4, 6 and 8 that are prepared using in each case equal quantitative fractions of the same kind of emulsifier types B).

### Example 10 (Use)

100 parts by weight of a commercial, aqueous, hydroxy-functional polyacrylate dispersion having a solids content of 45% and an OH content of 3.9%, based on resin solids, available under the name BAYHYDROL A 2470 (Covestro Deutschland AG, Leverkusen), were mixed with 1.2 parts by weight of a commercial defoamer (SURFYNOL 104BC, Air Products GmbH). This batch was admixed with 37.7 parts by weight of the inventive polyisocyanate from example 1 (corresponding to an equivalent ratio of isocyanate groups to alcoholic hydroxyl groups of 1.5:1) and the mixture was homogenized by stirring for five minutes at 1000 rpm. Thereafter the solids content was adjusted to 45% by addition of water.

For comparison, using the same method, clear varnishes were prepared in each case from 100 parts by weight of BAYHYDROL A 2470 and the polyisocyanates of examples 2 to 8 (corresponding in each case to an equivalent ratio of isocyanate groups to alcoholic hydroxyl groups of 1.5:1).

The working time of the application-ready mixtures in all cases was around 4 hours. The varnishes were applied in a wet film thickness of 150 μm (about 65 μm dry) to glass plates, and dried once each at room temperature (approximately 25° C.) and, in each case after flashing for 15 minutes, under forced conditions (30 min/60° C.). The table which follows shows technical paint properties of the coatings obtained.

| | | Example | Example 2 | Example | Example 4 | Example | Example 6 |
|---|---|---|---|---|---|---|---|
| Polyisocyanate from | | 1 | (comparative) | 3 | (comparative) | 5 | (comparative) |
| Polyisocyanate [parts by weight] ^{a)} | | 37.7 | 37.4 | 39.7 | 39.7 | 28.2 | 29.7 |
| Drying^{b)} min at 23° C. | T1 | 60 | 110 | 40 | 55 | 35 | 45 |
| | T2 | 310 | 480 | 330 | 430 | 240 | 280 |
| min at 60° C. | T2 | 25 | 50 | immediate | 30 | immediate | 20 |
| | T4 | 35 | 90 | 30 | 70 | 20 | 25 |

| | | | | | | |
|---|---|---|---|---|---|---|
| Pendulum hardness ^{c)} [s] after 1 d/7 d | 89/169 | 88/162 | 84/125 | 79/155 | 101/196 | 97/197 |
| Gloss 20°/60° | 86/92 | 85/91 | 86/92 | 86/92 | 85/92 | 86/91 |
| Haze | 14 | 18 | 11 | 15 | 17 | 15 |
| Solvent resistance ^{d)} | | | | | | |
| Water (30 min) | 0 | 0 | 1 | 1 | 0 | 0 |
| Xylene (5 min) | 0 | 0 | 0 | 1 | 0 | 0 |
| MPA (5 min) | 1 | 1 | 1 | 1 | 0 | 0 |
| Ethyl acetate (5 min) | 1 | 2 | 1 | 1 | 1 | 1 |
| Acetone (5 min) | 3 | 3 | 3 | 3 | 1 | 1 |

^{a)} based on 100 parts by weight of BAYHYDROL A 2470
^{b)}drying determined to DIN 53 150
^{c)} Konig pendulum hardness (DIN 53157), measured on varnish films dried at RT
^{d)} measured on varnish films dried at RT, after 7 days; rating: 0-5 (0 = varnish film unchanged; 5 = completely dissolved)

The comparison shows that by means of the inventive, hydrophilically modified polyisocyanate compositions from Examples 1, 3 and 5, coatings are obtained which in terms of their technical paint properties are at least equivalent to those produced using the analogously constructed hydrophilic HDI polyisocyanates from Examples 2, 4 and 6, and which are distinguished from the latter in particular by much quicker drying.

Various aspects of the subject matter described herein are set out in the following numbered clauses:

1. A polyisocyanate composition comprising a polyisocyanate component A) and an emulsifier component B), characterized in that the polyisocyanate component A) consists of at least one polyisocyanate based on 1,5-diisocyanatopentane and the emulsifier component B) comprises at least one ionic and/or nonionic emulsifier.

2. The polyisocyanate composition as in clause 1, characterized in that the composition has an average isocyanate functionality of 1.8 to 8.0, preferably of 2.0 to 7.0, and more preferably of 2.3 to 6.0, and/or has an isocyanate group content of 5.0 to 26.0 wt %, preferably 6.0 to 24.0 wt %, and more preferably of 10.0 to 23.0 wt %.

3. The polyisocyanate composition as in one of clauses 1 or 2, characterized in that the polyisocyanate component A) comprises at least one polyisocyanate which is obtainable by modification of 1,5-diisocyanatopentane and which has uretdione, isocyanurate, allophanate, biuret, iminooxadiazinedione and/or oxadiazinetrione structure, preferably isocyanurate and/or allophanate structure.

4. The polyisocyanate composition as in clause 3, characterized in that the polyisocyanate component A) consists of at least one polyisocyanurate having an average NCO functionality of 2.3 to 5.0 and/or an isocyanate group content of 11.0 to 26.0 wt %.

5. The polyisocyanate composition as in any one of clauses 1 to 4, characterized in that the emulsifier component B) comprises at least one reaction product of at least one polyisocyanate of the polyisocyanate component A) with a hydrophilic polyether alcohol.

6. The polyisocyanate composition as in clause 5, characterized in that the hydrophilic polyether alcohol is a polyethylene glycol monomethyl ether alcohol which contains on average 5 to 50 and preferably 5 to 25 ethylene oxide units.

7. The polyisocyanate composition as in one of clauses 5 and 6, characterized in that the reaction product comprises preferably ≥60 mol % of allophanate groups, based on the sum of urethane groups and allophanate groups.

8. The polyisocyanate composition as in any one of clauses 1 to 4, characterized in that the emulsifier component B) comprises at least one reaction product of at least one diisocyanate with at least one hydrophilic polyether alcohol.

9. The polyisocyanate composition as in any one of clauses 1 to 4, characterized in that the emulsifier component B) comprises at least one reaction product of at least one polyisocyanate of the polyisocyanate component A) with an aminosulfonic acid.

10. The polyisocyanate composition as in clause 9, characterized in that the aminosulfonic acid is selected from the group consisting of 2-(cyclohexylamino)-ethanesulfonic acid, 3-(cyclohexylamino)propanesulfonic acid, and 4-(cyclohexylamino)butanesulfonic acid.

11. The polyisocyanate composition as in any one of clauses 1 to 4, characterized in that the emulsifier component B) comprises at least one alkali metal salt or ammonium salt of an alkylphenol polyglycol ether phosphate, alkylphenol polyglycol ether phosphonate, fatty alcohol polyglycol ether phosphate, fatty alcohol polyglycol ether phosphonate, alkylphenol polyglycol ether sulfate and/or fatty alcohol polyglycol ether sulfate.

12. A method for producing the polyisocyanate composition as in any one of clauses 1 to 11, characterized in that the polyisocyanate component A) is mixed with the emulsifier component B), or the emulsifier component B) is formed in the polyisocyanate component A) by proportional reaction of polyisocyanates of the polyisocyanate component A) with ionic and/or nonionic compounds which carry groups that are reactive toward isocyanate groups.

13. The use of the polyisocyanate composition as in any one of clauses 1 to 11 for producing polyurethane plastics.

14. A coating composition comprising at least one polyisocyanate composition as in any one of clauses 1 to 11 and also at least one compound that is reactive toward isocyanate groups, and, optionally, further auxiliaries and adjuvants.

15. A coating obtainable by using a coating composition as in clause 14.

1. A polyisocyanate composition comprising a polyisocyanate component A) and an emulsifier component B), wherein the polyisocyanate component A) consists of at least one polyisocyanate based on 1,5-diisocyanatopentane and the emulsifier component B) comprises at least one ionic and/or nonionic emulsifier.

2. The polyisocyanate composition according to claim 1, wherein the composition has an average isocyanate functionality of 1.8 to 8.0, and/or has an isocyanate group content of 5.0 to 26.0 wt %.

3. The polyisocyanate composition according to claim 1, wherein the polyisocyanate component A) consists of at least one polyisocyanate obtained by modification of 1,5-diisocyanatopentane which has uretdione, isocyanurate, allophanate, biuret, iminooxadiazinedione and oxadiazinetrione structure.

4. The polyisocyanate composition according to claim 3, wherein the polyisocyanate component A) consists of at least one polyisocyanurate having an average NCO functionality of 2.3 to 5.0 and/or an isocyanate group content of 11.0 to 26.0 wt %.

5. The polyisocyanate composition according to claim 1, wherein the emulsifier component B) comprises at least one reaction product of at least one polyisocyanate of the polyisocyanate component A) with a hydrophilic polyether alcohol.

6. The polyisocyanate composition according to claim 5, wherein the hydrophilic polyether alcohol is a polyethylene glycol monomethyl ether alcohol which contains on average 5 to 50 ethylene oxide units.

7. The polyisocyanate composition according to claim 5, wherein the reaction product comprises ≥60 mol % of allophanate groups, based on the sum of urethane groups and allophanate groups.

8. The polyisocyanate composition according to claim 1, wherein the emulsifier component B) comprises at least one reaction product of at least one diisocyanate with at least one hydrophilic polyether alcohol.

9. The polyisocyanate composition according to claim 1, wherein the emulsifier component B) comprises at least one reaction product of at least one polyisocyanate of the polyisocyanate component A) with an aminosulfonic acid.

10. The polyisocyanate composition according to claim 9, wherein the aminosulfonic acid is selected from the group consisting of 2-(cyclohexylamino)-ethanesulfonic acid, 3-(cyclohexylamino)propanesulfonic acid, and 4-(cyclohexylamino)butanesulfonic acid.

11. The polyisocyanate composition according to claim 1, wherein the emulsifier component B) comprises at least one alkali metal salt or ammonium salt of an alkylphenol polyglycol ether phosphate, alkylphenol polyglycol ether phosphonate, fatty alcohol polyglycol ether phosphate, fatty alcohol polyglycol ether phosphonate, alkylphenol polyglycol ether sulfate and fatty alcohol polyglycol ether sulfate.

12. A method for producing the polyisocyanate composition according to claim 1, wherein the polyisocyanate component A) is mixed with the emulsifier component B), or the emulsifier component B) is formed in the polyisocyanate component A) by proportional reaction of polyisocyanates of the polyisocyanate component A) with ionic and/or nonionic compounds which carry groups that are reactive toward isocyanate groups.

13. In a process of producing polyurethane plastics, the improvement comprising including the polyisocyanate composition according to claim 1.

14. A coating composition comprising at least one polyisocyanate composition according to claim 1 and at least one compound that is reactive toward isocyanate groups, and, optionally, further auxiliaries and adjuvants.

15. A coating containing the coating composition according to claim 14.
